(19) United States
(12) Patent Application Publication
(10) Pub. No.: US 2022/0072938 A1
(43) Pub. Date: Mar. 10, 2022

(54) OPENING TRIM WEATHER STRIP

(71) Applicant: TOYODA GOSEI CO., LTD., Kiyosu-shi (JP)

(72) Inventors: Tetsuya TANAKA, Kiyosu-shi (JP); Makoto OKUTSU, Toyota-shi (JP); Sho KAWANABE, Miyoshi-shi (JP)

(21) Appl. No.: 17/470,140

(22) Filed: Sep. 9, 2021

(30) Foreign Application Priority Data
Sep. 10, 2020 (JP) 2020-152035

(51) Int. Cl. B60J 10/84; B60J 10/20

(52) U.S. Cl. CPC B60J 10/84; B60J 10/20

(57) ABSTRACT

An opening trim weather strip is attached to a flange of an opening of a vehicle body via a mounting base portion with a substantially U-shaped cross section including a vehicle outer side wall, a vehicle inner side wall, and a bottom wall connecting the vehicle outer side wall and the vehicle inner side wall. The opening trim whether strip includes a hollow seal portion integrated with the vehicle outer side wall of the mounting base portion, and a cover lip extending vehicle-inward from the bottom wall of the mounting base portion. A separate type or wire type insert is embedded in the mounting base portion. A tip part of the cover lip is provided with a tip thick walled portion which bulges toward the vehicle inner side wall side.

### CROSS-REFERENCE TO RELATED APPLICATIONS

This application is based on and claims priority under 35 USC 119 from Japanese Patent Application No. 2020-152035 filed on Sep. 10, 2020.

### TECHNICAL FIELD

The present disclosure relates to an opening trim weather strip for an automobile. The opening trim weather trip is attached along a peripheral edge of a door opening of a vehicle body of the automobile and comes into elastically contact with a door when the door is closed to seal a gap between the vehicle body and the door.

### BACKGROUND ART

Generally, an opening trim weather strip made of a rubber material such as EPDM is provided on a peripheral edge of a door opening of a vehicle such as an automobile. The opening trim weather strip is formed into a long shape with a constant cross-sectional shape by extrusion molding. As illustrated in FIG. 6, an opening trim weather strip 100 includes a mounting base portion 110 which has a substantially U-shaped cross section, a hollow seal portion 120 which is provided on a vehicle outer side of the mounting base portion 110 and integrated with the mounting base portion 110, and a cover lip 150 which is integrated with the mounting base portion 110 and extends vehicle-inward. The mounting base portion 110 includes a vehicle outer side wall 110a, a vehicle inner side wall 110b, and a bottom wall 110c which connects both side walls 110a and 110b.

The opening trim weather strip 100 is inserted into a flange of a vehicle body from an opening portion 110d side of the mounting base portion 110. To fit and hold the flange, the mounting base portion 110 includes a claw portion 130 which comes into elastic contact with the flange provided inside the vehicle inner side wall 110b, and a plurality of protrusion portions 140 which is provided inside the vehicle outer side wall 110a.

An insert 200 (also referred to as a “core material”) is embedded in the mounting base portion 110 in order to increase rigidity of the mounting base portion 110. The insert 200 is embedded along a longitudinal direction when the mounting base portion 110 is formed by extrusion.

As illustrated in FIG. 7, the insert 200 is made of metal and includes a plurality of strip-shaped bone fragment portions 210 which is arranged substantially parallel to each other, and a connection portion 220 which connects the bone fragment portions 210. FIG. 7 illustrates a so-called center bond type in which the connection portion 220 is provided near a center of the bone fragment portion 210 in a width direction (for example, JP-A-2010-274764).

Also, in order to reduce the weight of the insert, there are proposed a separation type (for example, JP-A-2010-52507) in which initially connected bone fragments are separated after extrusion molding and a wire type (for example, JP-A-2019-156253) in which one metal wire is formed in a wavy shape and connected by a non-hot melt yarn.

By the way, when assembling the opening trim weather strip 100 to a corner portion of a peripheral edge of a door opening, in order to follow a curved shape of the corner portion, it is necessary to bend the opening trim weather strip 100 in a longitudinal direction so that the bottom wall 110c is to be inside a curve. When bending the corner portion, in the lightweight opening trim weather strip using a separate type or wire type insert, a problem in which the opening trim weather strip 100 rotates significantly in a direction of the arrow X in FIG. 6, and it becomes difficult to assemble the opening trim weather strip 100 to the flange occurs. This problem does not occur in the opening trim weather strip 100 using a center bond type insert.

FIG. 6 illustrates the opening trim weather strip 100 which uses a center bond type insert and illustrates a cross-sectional view at a position where the bone fragment portion 210 is present. In the opening trim weather strip 100, a neutral axis position (a position where neither elongation nor shrinkage occurs when the corner portion is bent) is on the insert 200 of the bottom wall 110c as illustrated by the alternate long and short dash line A.

However, in the lightweight opening trim weather strip which uses a separation type or wire type insert instead of the center bond type insert 200 described above, the neutral axis moves to a position of the alternate long and short dash line B in FIG. 6. It is also pointed out in JP-A-2019-156253 that the neutral axis moves to the position of the alternate long and short dash line B in the opening trim weather strip which is lightened by using a wire type insert.

As a result, a position of a cross-sectional center of gravity existing on the neutral axis also moves to G′. When the corner portion is bent, the bottom wall 110c side of the neutral axis (alternate long and short dash line B) is compressed and an opposite side is expanded. Therefore, it is considered that the rotation is largely performed in the direction of the arrow X in FIG. 6 with the position of the cross-sectional center of gravity G′ as a center of rotation.

Therefore, the present disclosure focuses on a cover lip, which is a component of the opening trim weather strip, in which a separation type or wire type insert is embedded and the weight is reduced. An object of the present disclosure is to provide an opening trim weather strip which suppresses the rotation of the opening trim weather strip during bending of the corner portion and improves an assembling property to the flange of the vehicle body.

### SUMMARY OF INVENTION

According to an aspect of the present disclosure, there is provided an opening trim weather strip being attached to a flange of an opening of a vehicle body via a mounting base portion with a substantially U-shaped cross section including a vehicle outer side wall, a vehicle inner side wall, and a bottom wall connecting the vehicle outer side wall and the vehicle inner side wall, the opening trim whether strip including:

a hollow seal portion integrated with the vehicle outer side wall of the mounting base portion; and

a cover lip extending vehicle-inward from the bottom wall of the mounting base portion, in which:

a separate type or wire type insert is embedded in the mounting base portion; and

a tip part of the cover lip is provided with a tip thick walled portion which bulges toward the vehicle inner side wall side.

According to the aspect of the present disclosure, there is provided an opening trim weather strip which includes a mounting base portion with a substantially U-shaped cross section including a vehicle outer side wall, a vehicle inner side wall, and a bottom wall connecting the vehicle outer side wall and the vehicle inner side wall, a hollow seal portion integrated with the vehicle outer side wall of the mounting base portion, and a cover lip extending vehicle-inward from the bottom wall of the mounting base portion and which is attached to a flange of an opening of a vehicle body via the mounting base portion, where a separate type or wire type insert is embedded in the mounting base portion and a tip part of the cover lip is provided with a tip thick walled portion which bulges toward the vehicle inner side wall portion side. That is, by increasing a volume of a location far from a cross-sectional center of gravity position of the related art, a cross-sectional center of gravity position of the opening trim weather strip can be moved to the bottom wall side and the vehicle inner side wall side. As a result, rotation of the opening trim weather strip can be suppressed during bending of a corner portion and an assembling property to the flange of the vehicle body can be improved.

Since the tip thick walled portion is formed by bulging to the vehicle inner side wall portion side, there is no change in an appearance of an opposite side to a side to be inserted into the flange of the cover lip which covers end portions of interior parts such as the ceiling and garnish, and there is no effect on the performance.

Although the weight of the cover lip is increased by forming the tip thick walled portion, the separation type or wire type insert is used. Therefore, compared to an opening trim weather strip which uses a center bond type insert, the weight can still be reduced.

In the opening trim weather strip according to the aspect of the present disclosure, the cover lip includes a thin-walled connection portion extending vehicle-inward from a central portion of the bottom wall or a portion of the bottom wall further on the vehicle outer side wall side than the central portion.

In the opening trim weather strip according to the aspect of the present disclosure, the cover lip includes a thin-walled connection portion extending vehicle-inward from a central portion of the bottom wall or a portion of the bottom wall further on the vehicle outer side wall side than the central portion. That is, by reducing a volume of the cover lip near the cross-sectional center of gravity position of the related art, a force of being compressed and returning to an original length during bending of the corner portion can be reduced. As a result, the rotation of the opening trim weather strip can be further suppressed during bending of the corner portion and the assembling property to the flange of the vehicle body can be improved.

Also, since the cover lip extends vehicle-inward from a portion of the bottom wall further on the vehicle outer side wall side than the central portion of the bottom wall, there is no change in an appearance of an opposite side to a side to be inserted into the flange of the cover lip which covers end portions of interior parts such as the ceiling and garnish, and there is no effect on the performance.

Furthermore, further weight reduction can be achieved by including the thin-walled connection portion and reducing the volume of the connection part between the bottom wall and the cover lip.

Here, the central portion of the bottom wall means a central position between outer sides of both the vehicle outer side wall and the vehicle inner side wall when the vehicle outer side wall and the vehicle inner side wall are bent vertically with respect to the bottom wall.

There is provided an opening trim weather strip which includes a mounting base portion with a substantially U-shaped cross section including a vehicle outer side wall, a vehicle inner side wall, and a bottom wall connecting the vehicle outer side wall and a vehicle inner side wall, a hollow seal portion and a cover lip which are integrated with the mounting base portion, and which is attached to a flange of an opening of a vehicle body via the mounting base portion, where a separate type or wire type insert is embedded in the mounting base portion and a tip part of the cover lip is provided with a tip thick walled portion which bulges toward the vehicle inner side wall portion side. That is, by increasing a volume of a location far from a cross-sectional center of gravity position of the related art, a cross-sectional center of gravity position of the opening trim weather strip can be moved to the bottom wall side and the vehicle inner side wall side. As a result, rotation of the opening trim weather strip can be suppressed during bending of a corner portion and an assembling property to the flange of the vehicle body can be improved.

Since the tip thick walled portion is formed by bulging to the vehicle inner side wall portion side, there is no change in an appearance of an opposite side to a side to be inserted into the flange of the cover lip which covers end portions of interior parts such as the ceiling and garnish and there is no effect on the performance.

Although the weight of the cover lip is increased by forming the tip thick walled portion, the separation type or wire type insert is used. Therefore, compared to an opening trim weather strip which uses a center bond type insert, the weight can still be reduced.

### BRIEF DESCRIPTION OF DRAWINGS

FIG. 1 is a perspective view illustrating an automobile.

FIG. 2 is a side view illustrating an opening trim weather strip mounted on a flange.

FIG. 3 is a cross-sectional view illustrating an opening trim weather strip according to a first embodiment of the present disclosure and is a cross-sectional view taken along the line C-C of FIG. 2.

FIGS. 4A to 4C are views illustrating an insert used for the opening trim weather strip according to the first embodiment of the present disclosure, where FIG. 4A illustrates a metal plate forming the insert, FIG. 4B is a partially enlarged plan view before separation processing, and FIG. 4C is a partially enlarged plan view before bending processing.

FIG. 5 is a cross-sectional view illustrating an opening trim weather strip according to a second embodiment of the present disclosure and is a cross-sectional view taken along the line C-C of FIG. 2.

FIG. 6 is a view for illustrating a neutral axis and a position of a cross-sectional center of gravity in an opening trim weather strip of the related art.

FIG. 7 is a view illustrating a center bond type insert of the related art (JP-A-2010-274764).

### DESCRIPTION OF EMBODIMENTS

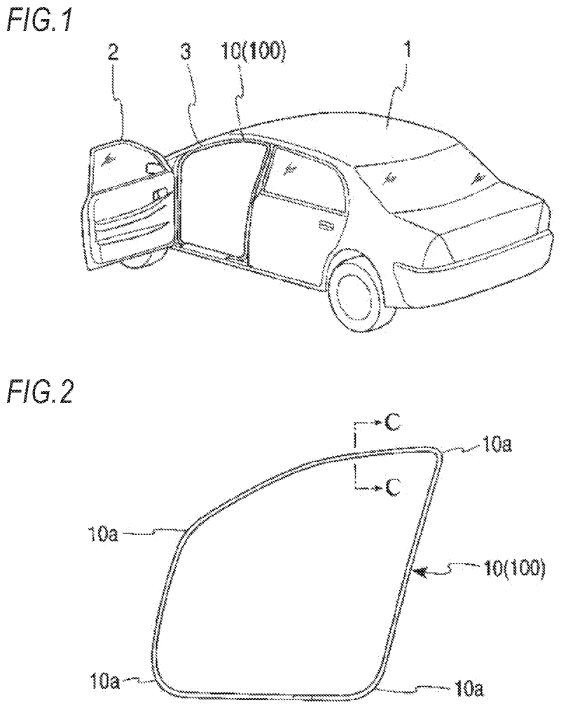

A first embodiment of the present disclosure will be described with reference to FIGS. 1 to 4C. As illustrated in FIG. 1, an opening trim weather strip 10 of the present embodiment is mounted on a flange of the peripheral edge 3 of a door opening on a vehicle body 1 side corresponding to a side door 2 of a vehicle body 1 of an automobile.

As illustrated in FIG. 2, the opening trim weather strip 10 is formed into a long shape having a constant cross section by an extrusion molding method and is bent at a corner portion 10a according to a shape of the peripheral edge 3 of the door opening on the vehicle body 1 side.

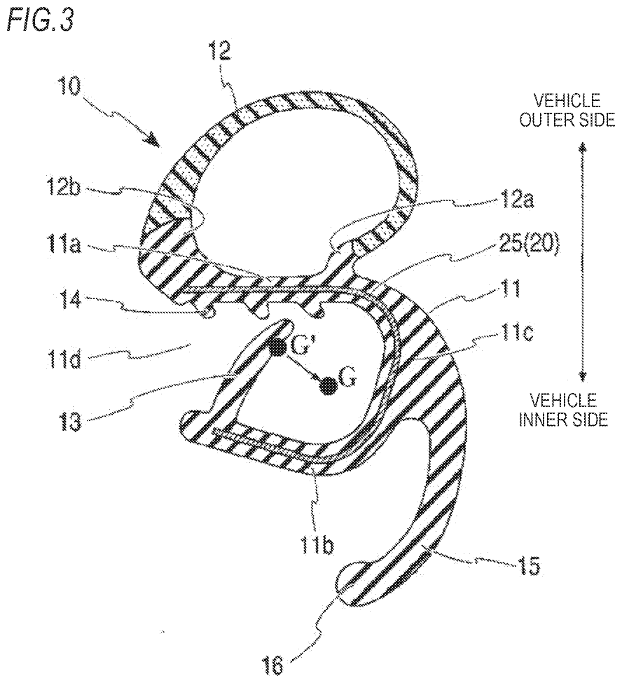

The opening trim weather strip 10 according to the first embodiment of the present disclosure will be described with reference to FIG. 3. FIG. 3 illustrates the opening trim weather strip 10 in which a separation type insert 20 described below is embedded and is a cross-sectional view at a position where the insert 20 exists. Also, FIG. 3 is a cross-sectional view taken along the line C-C of FIG. 2.

The opening trim weather strip 10 mainly includes a mounting base portion 11, a hollow seal portion 12, the insert 20, and a cover lip 15.

The mounting base portion 11 has a substantially U-shaped cross section including a vehicle outer side wall 11a, a vehicle inner side wall 11b, and a bottom wall 11c connecting both side walls 11a and 11b. The mounting base portion 11 is inserted into a flange (not illustrated) provided along the peripheral edge 3 of the door opening of the vehicle body 1 from an opening portion 11d side and attached to the flange. In the present embodiment, the mounting base portion 11 uses a solid material of ethylene propylene diene rubber (EPDM) as a material.

The hollow seal portion 12 bulges and curves toward the outside of the vehicle from bases 12a and 12b which protrudes toward an inner peripheral side and an outer peripheral side of the door in the vehicle outer side wall 11a of the mounting base portion 11. When the door is closed, the hollow seal portion 12 comes into elastically contact with the door 2 to seal the inside and outside of the vehicle. In the present embodiment, an EPDM sponge material is used for the hollow seal portion 12. For the hollow seal portion 12, a sponge material may be used on a seal surface side and a solid material may be used on a side other than the seal surface side.

The cover lip 15 is formed to extend vehicle-inward from the bottom wall 11c in a convex arc shape in a direction opposite to the hollow seal portion 12 side. When the opening trim weather strip 10 is mounted on the vehicle body 1, a tip part of the cover lip covers an end portion of an interior part such as a ceiling or a garnish (not illustrated). At the tip part of the cover lip 15, an arc-shaped tip thick walled portion 16 which bulges toward the vehicle inner side wall 11b side is formed. In the present embodiment, an EPDM solid material is used as the cover lip 15.

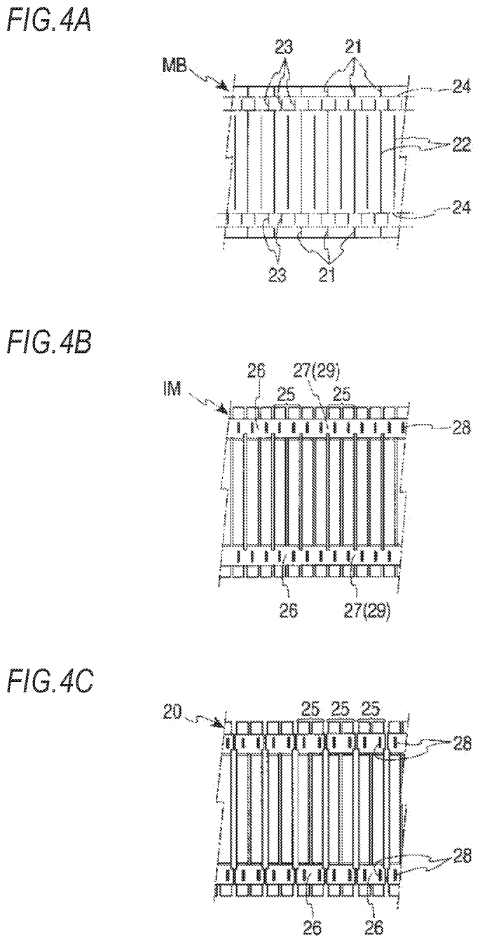

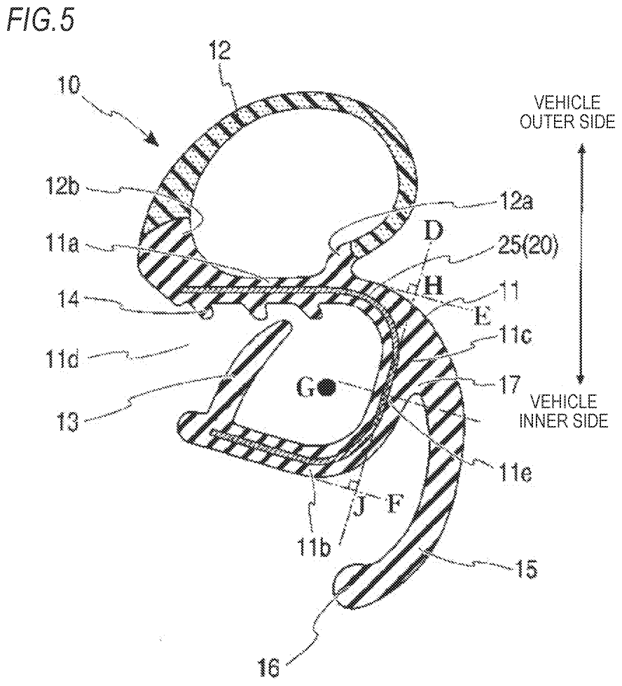

The insert 20 is a separation type which divides initially connected bone fragments after extrusion molding, and the one described in JP-A-2010-52507 is used. The insert 20 will be outlined below based on FIGS. 4A to 4C.

The insert 20 is an iron metal plate MB. As illustrated in FIG. 4A, at both ends of the insert 20 in a width direction, a plurality of end portion slits 21 extending in the width direction are formed, and a plurality of central slits 22 extending along the width direction of the metal plate MB are formed in a form which is interposed between the end portion slits 21. Further, a plurality of through-hole slits 23 extending in the width direction are formed in a central part along a longitudinal direction of the metal plate MB between regions located between the end portion slit 21 and the central slit 22. As the central slit 22, relatively long slits 22 and relatively short slits 22 are alternately formed along the width direction of the metal plate MB.

By rolling the metal plate MB, as illustrated in FIG. 4B, a pair of strip portions 24 extending in the longitudinal direction with a region located between the end portion slit 21 and the central slit 22 included are rolled and the slits 21 and 22 are widened in the longitudinal direction. Therefore, a plurality of bone fragment bodies 25 and a connection portion 26 (a plurality of fine connection portions 27 in the connection portion 26) connecting each bone fragment body 25 are formed. At the same time, the through-hole slit 23 is widened in the longitudinal direction to form a through-hole 28 and an insert intermediate body IM is obtained. The relatively narrow fine connection portion 27 located between the relatively long central slit 22 and the end portion slit 21 becomes a planned cutting portion 29 to be cut at the time of the later separation processing.

Extrusion molding is performed using the insert intermediate body IM, and after vulcanization processing, the vulcanized insert intermediate body IM is guided to a separator (not illustrated) equipped with a plurality of rollers and moved along each roller in a meandering state, and then bending back and unbending are performed a plurality of times with respect to the planned cutting portion 29. As a result, as illustrated in FIG. 4C, the planned cutting portion 29 is cut and the insert 20 is formed in which the bone fragment bodies 25 are separated from each other. Then, after this, bending processing is performed so that the cross section is substantially U-shaped. For details on the insert 20, it is referred to JP-A-2010-52507. Further, the separation type insert is not limited to the insert 20.

On the inside (outside of the vehicle) of the vehicle inner side wall 11b of the mounting base portion 11, a claw portion 13 is provided to extend toward the vehicle outer side wall 11a, and the claw portion 13 comes into elastic contact with and holds the flange so as to pinch the flange together with a plurality of protrusion portions 14 provided inside the vehicle outer side wall 11a of the mounting base portion 11. In the present embodiment, an EPDM solid material is used for both the claw portion 13 and the protrusion portion 14.

As a result of producing the opening trim weather strip 10 in which an arc-shaped tip thick walled portion 16 bulging toward the vehicle inner side wall 11b side is formed at a tip part of the cover lip 15 described above, as illustrated in FIG. 3, a position of the cross-sectional center of gravity moves from G′ when the tip thick walled portion 16 is not formed to G. This realize that the cross-sectional center of gravity position moves to the bottom wall side and the vehicle inner side wall side by increasing a volume of the tip part of the cover lip 15, which is the location far from the cross-sectional center of gravity position G′ of the related art.

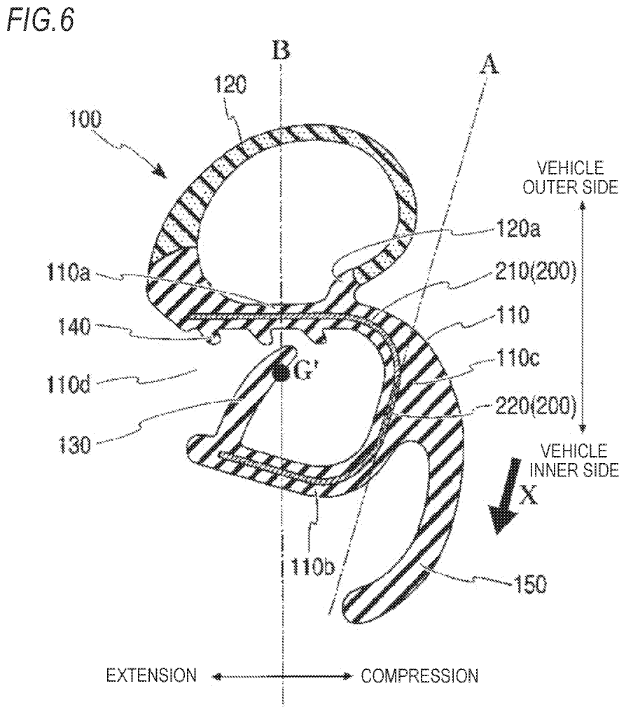

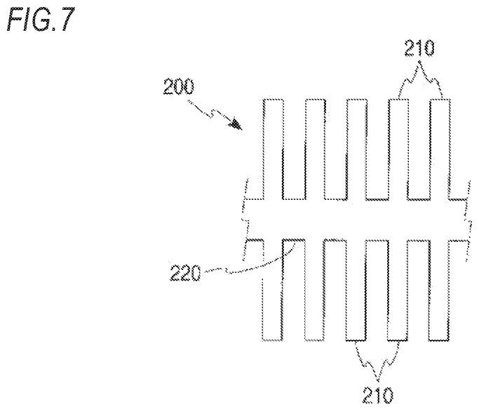

As a result, in the corner portion 10a, when the bottom wall 11c is bent to be inside the curve, the rotation of the opening trim weather strip 10 in a direction of the arrow X in FIG. 6 can be suppressed, and the assembling property to the flange of the vehicle body 1 can be improved. Since the tip thick walled portion 16 is formed by bulging to the vehicle inner side wall 11b side, there is no change in the appearance of an opposite side to the opening portion 11d side to be inserted into the flange of the cover lip 15 which covers end portions of interior parts such as the ceiling and garnish, and there is no effect on the performance.

Although the weight of the cover lip 15 is increased by forming the tip thick walled portion 16, the separation type insert 20 is used. Therefore, compared to the opening trim weather strip which uses a center bond type insert, the weight can still be reduced.

Next, a second embodiment of the present disclosure will be described with reference to FIG. 5. The second embodiment differs from the first embodiment in that the cover lip 15 is provided with a thin-walled connection portion 17 extending vehicle-inward from a central portion 11e of the bottom wall 11c or the bottom wall 11c further on the vehicle outer side wall 11a side than the central portion 11e. In FIG. 5, the cover lip 15 extends vehicle-inward from the bottom wall 11c further on the vehicle outer side wall 11a side than the central portion 11e of the bottom wall 11c.

Here, the central portion 11e of the bottom wall 11c means a central position between outer sides of both the vehicle outer side wall 11a and the vehicle inner side wall 11b when the vehicle outer side wall 11a and the vehicle inner side wall 11b are bent vertically with respect to the bottom wall 11c. That is, in FIG. 5, when an intersection with an outer line (alternate long and short dash line E) of the vehicle outer side wall 11a when the vehicle outer side wall 11a is bent vertically with respect to the alternate long and short dash line D relating to the bottom wall 11c is set as H and an intersection with an outer line (alternate long and short dash line F) of the vehicle inner side wall 11b when the vehicle inner side wall 11b is bent vertically with respect to the dashed line D is set as J, a central position of a line segment HJ is the central portion 11e.

By providing a thin-walled connection portion 17 and reducing the volume of a connection part between the bottom wall 11c and the cover lip 15, during the bending process of the corner portion 10a, the force of being compressed and returning to the original length at this portion can be reduced. As a result, in the corner portion 10a, when the bottom wall 11c is bent inside the curve, the rotation of the opening trim weather strip 10 in the direction of the arrow X in FIG. 6 is further suppressed and the assembling property to the flange of the vehicle body 1 can be improved.

Also, the cover lip 15 is extended vehicle-inward from the bottom wall 11c further on the vehicle outer side wall 11a side than the central portion 11e of the bottom wall 11c. Therefore, there is no change in the appearance of the opposite side to the opening portion 11d side to be inserted into the flange of the cover lip 15 which covers the end portions of the interior parts such as the ceiling and garnish and there is no effect on the performance.

Further, the weight can be further reduced by including the thin-walled connection portion 17 and reducing the volume of the connection part between the bottom wall 11c and the cover lip 15.

Regarding the cross-sectional center of gravity position G in FIG. 5, the volume of a base part of the cover lip 15, which is a location close to the cross-sectional center of gravity position G in FIG. 3, is reduced. Therefore, the change from the cross-sectional center of gravity position G in FIG. 3 is slight.

Although both the first embodiment and the second embodiment are described in relation to the separation type insert 20, the present disclosure can also be applied to a wire type insert.

The practice of the present disclosure is not limited to the embodiments described above and various modifications can be made as long as the object of the present disclosure does not deviate.

For example, in the present embodiment, EPDM is used as a rubber material as the material forming the opening trim weather strip 10, but it may be formed of a thermoplastic elastomer, a soft synthetic resin, or the like. As the thermoplastic elastomer, an olefin-based thermoplastic elastomer (TPO) and a dynamically crosslinked thermoplastic elastomer (TPV) are desirable from the viewpoints of weather resistance, recycling, cost, and the like. When a thermoplastic elastomer is used, the above vulcanization processing becomes unnecessary.

What is claimed is:

1. An opening trim weather strip being attached to a flange of an opening of a vehicle body via a mounting base portion with a substantially U-shaped cross section including a vehicle outer side wall, a vehicle inner side wall, and a bottom wall connecting the vehicle outer side wall and the vehicle inner side wall, the opening trim whether strip comprising:
a hollow seal portion integrated with the vehicle outer side wall of the mounting base portion; and
a cover lip extending vehicle-inward from the bottom wall of the mounting base portion, wherein:
a separate type or wire type insert is embedded in the mounting base portion; and
a tip part of the cover lip is provided with a tip thick walled portion which bulges toward the vehicle inner side wall side.

2. The opening trim weather strip according to claim 1, wherein
the cover lip includes a thin-walled connection portion extending vehicle-inward from a central portion of the bottom wall or a portion of the bottom wall further on the vehicle outer side wall side than the central portion.
